(19) United States
(12) Patent Application Publication
(10) Pub. No.: US 2018/0354177 A1
(43) Pub. Date: Dec. 13, 2018

(54) APPARATUS FOR INJECTION MOULDING OF PLASTIC MATERIALS

(71) Applicant: INGLASS S.p.A., San Polo di Piave (Treviso) (IT)

(72) Inventor: Maurizio BAZZO, San Polo di Piave (Treviso) (IT)

(21) Appl. No.: 16/000,963

(22) Filed: Jun. 6, 2018

(30) Foreign Application Priority Data
Jun. 8, 2017 (IT) 102017000062960

(51) Int. Cl. B29C 45/76; B29C 45/03; B29C 45/28

(52) U.S. Cl. CPC B29C 45/76; B29C 45/03; B29C 2945/76993; B29C 2045/2824; B29C 45/281

(57) ABSTRACT

An apparatus for injection molding of plastic materials includes a mold, at least one injector having a valve pin actuated by an electric motor, and a supply and control unit of the electric motor. The supply and control unit includes a memory and remote control drivers of the electric motor operatively connected to the memory. At least one part of the memory is separated from the drivers, arranged at a remote position with respect to the mold, and is fixed to the mold.

### FIELD OF THE INVENTION

The present invention refers to apparatus for injection moulding of plastic materials including a mould comprising a distributor of plastic material to be injected, at least one injector including a nozzle with respect to which a valve pin is moveable, and actuator means for controlling the displacement of the valve pin between a closing position and an opening position to enable the flowing of the pressurised fluid plastic material from the distributor to the mould cavity.

### State of the Prior Art

Conventionally, actuator means for controlling the valve pin of the or of each injector consist in fluid actuators which entail considerable complications due to the need of providing dedicated systems and pipings for supplying oil and air, as well as almost zero control options except for an ON/OFF actuation. In addition, there are problems related to cleaning, and overall dimensions due to the presence of the pipings.

Actuation systems employing electric motors, in particular of the rotary type, and provided with devices for detecting the position of the valve pin, for example an encoder or resolver associated to the shaft of the rotary motor and connected to a stand-alone electronic unit by means of which a prompt and precise control of the position, speed and acceleration of the valve pin is carried out, were proposed with the aim of overcoming these drawbacks. The electronic unit is usually provided separately with respect to the mould and it is designed to be indistinctly combined with any mould provided with electric actuators, regardless of the number thereof.

However, the undeniable advantages in terms of flexibility and precision in controlling the moulding process have a negative impact on the supply and operating costs of the equipment and the overall dimensions in the work area. Examples regarding this are described and illustrated for example in the European patent applications numbers EP-2679374A1, EP-2918389A1 and EP-3009251A1, all on behalf of the Applicant. In the concrete application of the solutions described in these documents, whose costs are high and considerably higher than those of fluid actuators, the rotary electric motors are of the alternating current type provided with an encoder or resolver and combined with a stand-alone electronic unit.

FIG. 1 of the attached drawings schematically represents such arrangement: the mould, indicated with 1, receives—from a moulding press 2—the plastic material which is injected by one or more conventional injectors (not illustrated), whose valve pin is controlled by an electric motor in turn controlled by an electronic control unit 3 of the “stand alone” type, i.e. external with respect to the mould 1, which conventionally integrates a memory 4 and the drivers 5 for the actuation of the electric motors. Furthermore, there are present other elements required for the proper operation such as for example electrical power supply 7 and connection 8 connectors for the electric motors and respective encoders or resolvers. Lastly, there is usually present a control panel 9 (e.g. PLC) that can be used for configuring the drivers 5 and the real time display of the main parameters during the moulding cycles.

In order to partly overcome these drawbacks, the Applicant proposed a simpler, more cost-effective and less cumbersome alternative to the prior art systems with the aforementioned electric motors, while maintaining the undeniable advantages with respect to systems with fluid actuators in terms of construction simplicity of the apparatus, cleaning and possibility of adjusting the main opening and closing parameters of the single injector.

In such proposal, described and illustrated in the international patent application WO2017098345 in the name of the Applicant, the power supply and control unit is fixed to the mould and uniquely associated thereto. The supply and control unit is preferably fixed to the fixing plate of the mould and the electrical supply is provided by means of connectors located on the unit, while the control of the main parameters for opening and closing the injectors occurs by suitably controlling the driver of the circuit board associated to each electric motor and positioned in the unit.

This configuration is schematically represented in FIG. 2 of the attached drawings: as mentioned, the entire power supply and control unit 3, with the memory 4 and the drivers 5, is fixed to the mould 1.

The configuration of the main parameters is carried out by the operator for example by means of an outer universal control panel 9 (e.g. PLC), that can be used for configuring the drivers 5 for example by means of appropriate connection to the memory connector 10 present on the power supply and control unit 3.

This enables at least partly obtaining the advantages of the electric motors provided for in the aforementioned prior art solutions, but eliminating the use of a stand-alone electronic control unit, thus cutting costs considerably and reducing the overall dimension in the work area.

The costs still remain considerably high given that every mould is actually provided with its own control unit 3 complete with all the elements (e.g. circuit boards, drivers 5, memory 4, memory 10 and power supply 7 connector), though small in size and smaller overall dimensions with respect to the stand-alone electronic unit.

The overall dimensions of the unit fixed to the mould 1 can give rise to problems in some cases during the step of transporting and installing in the dedicated moulding press.

Furthermore, there is no advantage in terms of time for the operator, given that there still arises the need for configuring the main parameters suitably controlling the circuit board driver 5, prior to staring the moulding process.

DE-102004052499 generally discloses an injection molding tool with electronic control module wherein a data storage unit of molding parameters is secured to the mold and is connected via a communication interface to a control unit of the injection apparatus.

### SUMMARY OF THE INVENTION

The object of the present invention is to further reduce the costs, overall dimensions and start-up times of the moulding apparatus.

This object is attained according to the invention mainly due to the fact that part of the power supply and control unit, with particular reference to the electric motors control drivers, is not fixed to the mould, while another part of the power supply and control unit, specifically at least one part of the memory, is separated from the drivers and it is fixed to the mould. This part of memory can serve as an “identity card” of the mould.

Thus, the invention enables providing an independent control unit containing the drivers having the advantage lying in the fact that it can be combined with many different moulds.

In this manner, the purchaser of the moulding apparatus will need to be equipped with only one of these independent control units for all electrical actuation systems in his possession, thus saving on buying a considerable number of drivers which account for the highest costs of the control unit according to the prior art.

### BRIEF DESCRIPTION OF THE DRAWINGS

In the attached drawings provided by way of non-limiting example:

FIG. 1 is a schematic view representing an injection moulding apparatus according to the first prior art described previously,

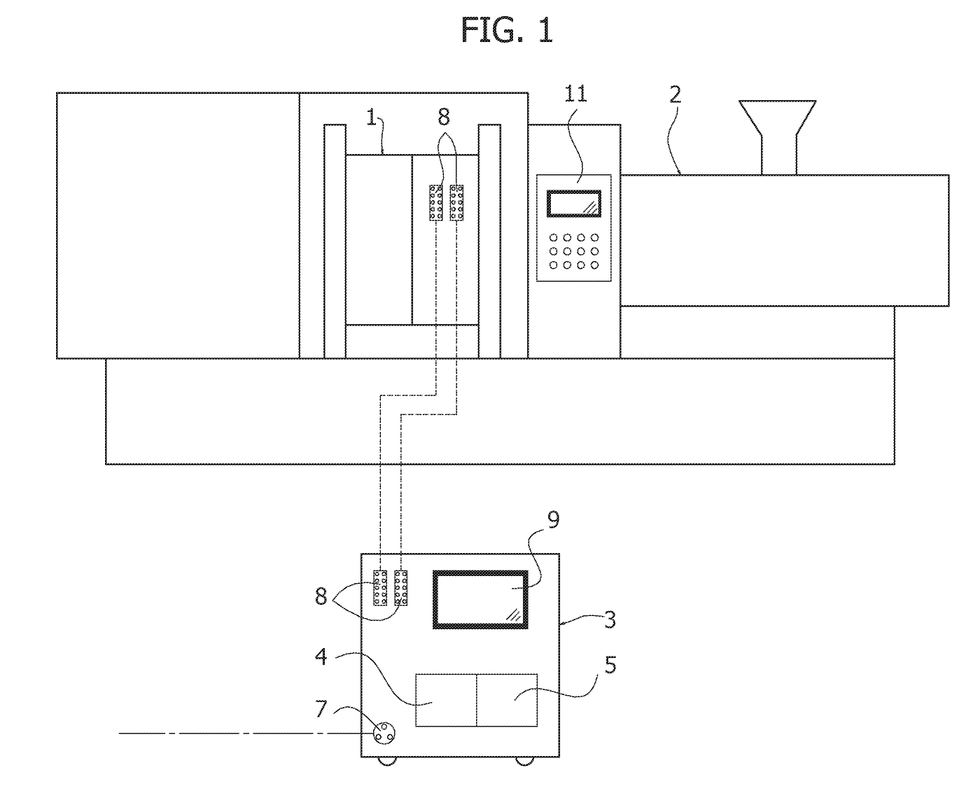

FIG. 2 is a view analogous to FIG. 1 representing an injection moulding apparatus corresponding to the second prior art described previously,

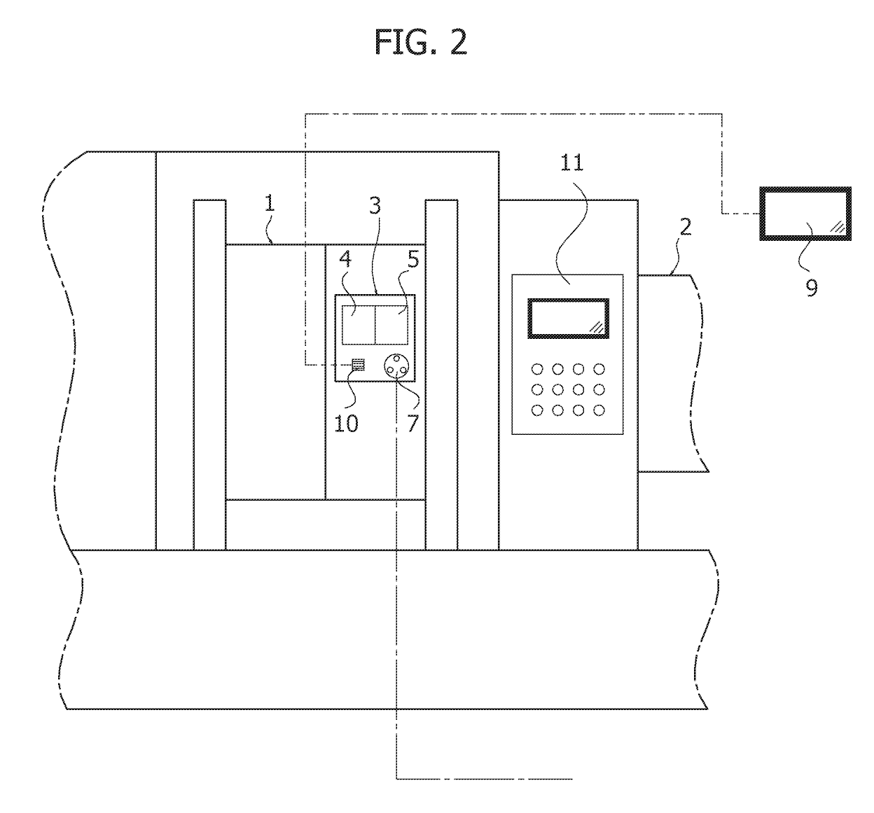

FIG. 3 is a view analogous to FIG. 1 representing an injection moulding apparatus according to a first embodiment of the invention, and

FIG. 4 is a view analogous to FIG. 3 representing an injection moulding apparatus according to a second embodiment of the invention.

### DETAILED DESCRIPTION OF THE INVENTION

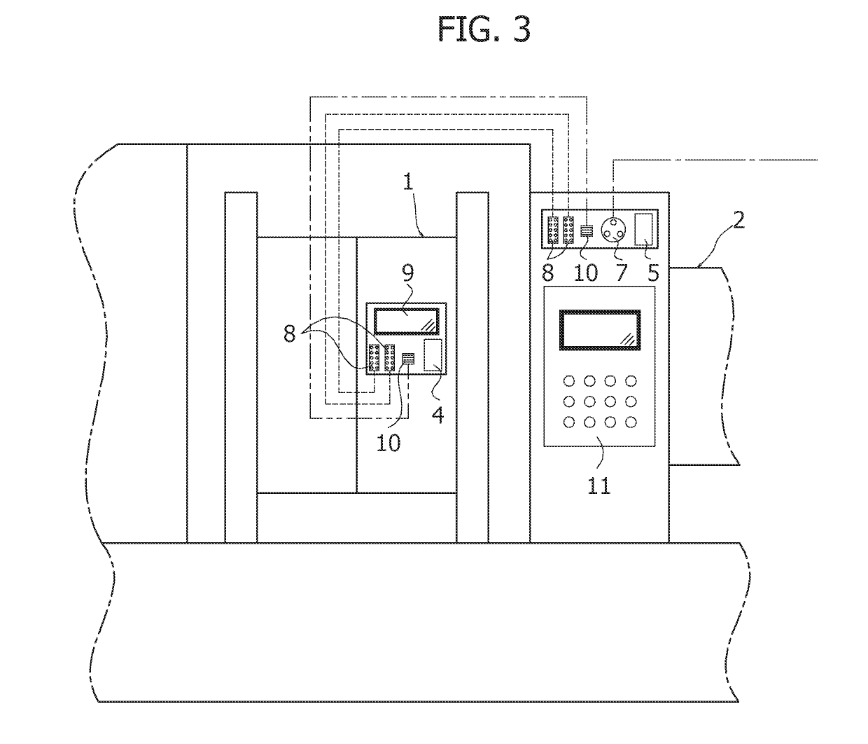

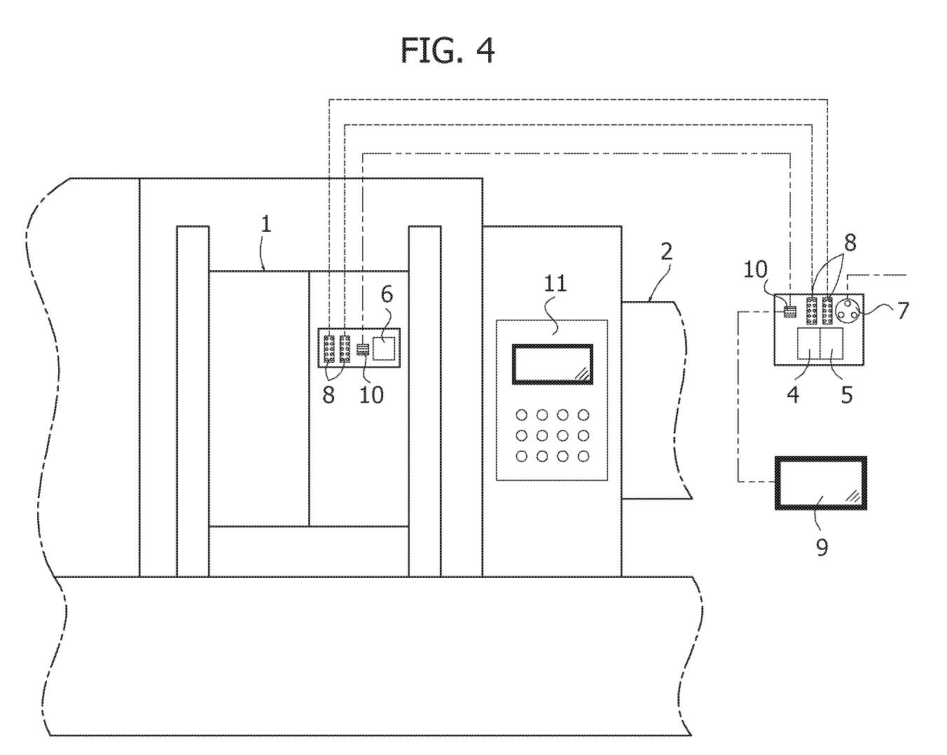

In both embodiments of the invention exemplified in FIGS. 3 and 4, one part of the power supply and control unit 3, in particular at least one part of a specific memory 4 or 6, is fixed to the mould 1 while another part of the power supply and control unit 3, the control drivers 5 of the electric motors of the of the obturators of the injectors in particular, is provided outside the mould 1.

According to the first embodiment of the invention schematised in FIG. 3, the drivers 5 can be inserted into a box separated from the mould 1, for example fixed to the moulding press 2 of the moulding apparatus.

In particular all moulds that use electric motors for displacing the obturators already provide for a safety interface box to be combined with the moulding press. Thus, the drivers 5 could be inserted into the safety interface box, or into a further independent box.

Alternatively, the moulding press 2 of the apparatus could be directly provided with drivers 5, integrated in the control unit thereof. For example, let us consider an electrical actuation moulding press provided to be combined with a system for actuating the obturators of the injectors (electrical too): thus, an all-electric system that is easy to manage can be created according to the invention.

In a preferred solution visible in FIG. 4, the drivers 5 are contained in a small independent box and which can be easily handled by a user, for example so as to be able to displace it from one moulding press to another and thus combine it with different moulds.

As mentioned, this new independent unit containing the drivers 5 is not sufficient to guarantee the proper actuation of the electric actuators in the mould. As a matter of fact, the primary memory 4 containing the instructions for controlling the main parameters for opening and closing the injectors, to be carried out by the drivers 5, is also required.

According to the first embodiment schematised in FIG. 3, the primary memory 4 is fixed to the mould 1, obviously with considerably smaller overall dimensions that facilitate transportation and installation. For example, a box containing the primary memory 4 can be fixed to a plate of the mould 1, or to the support structure of the wiring regarding the hot runner or distributor of the plastic material to the injectors.

According to a further possibility, the memory 4 containing the instructions regarding each electric motor for actuating the obturator of the respective injector, is integrated in the electric motor.

Connecting the independent box containing the drivers 5 to the memory 4 fixed to the mould 1 by means of special control 8 and memory 10 connectors, the drivers 5 automatically download the specific instructions to be followed by the respective electric actuators, without requiring any intervention or configuration by the user, thus saving time considerably. The instructions could for example have been previously uploaded in the memory 4 by the supplier of the injection apparatus, so as to deliver the system to the customer already ready for connection to the drivers and thus made operative automatically.

The instructions can be set in the memory automatically, for example by transferring the results of a dynamic software simulation (for example the one referred to as “MoldFlow®”) by means of a special external medium (USB flash drive, SD card, etc.) to the memory 4.

Alternatively, the instructions can be set in the memory manually, for example through a human-machine interface (HMI) such as a control panel 9 (e.g. PLC) integrally joined to the box of the memory as observable in FIG. 3, or even through dedicated potentiometers or push buttons still integrally joined to the box.

According to an advantageous alternative visible in FIG. 4, the control panel (e.g. PLC) is not integrally joined to the box of the memory 4, but rather independent so that it can be used for setting the instructions of different systems by means of suitable connections 10. Once through with setting, the control panel can be disconnected and used for another system, without jeopardising the functionality of the previous one.

Alternatively, the manual setting could be carried out by means of electronic devices such as PCs, tablets or smartphones using a dedicated software.

In this case too, the electronic device can be disconnected at the end of the setting without jeopardising the functionalities. According to a further alternative, the instructions can be uploaded directly from the control panel of moulding press 11, still through suitable connection with the primary memory 4.

The purchaser of the moulding apparatus may obviously be allowed to change the instructions or enter new ones into the memory using one of the methods described above.

Furthermore, the instructions can be transferred from one system to another for example by means of an external medium (e.g. USB flash drive, SD card, etc.) and a special communication port provided for on the box of the primary memory 4 or on the panel of the moulding press 11.

The second embodiment, schematised in FIG. 4, instead provides for that also the memory 4 be no longer fixed to the mould 1, but be provided externally alongside the drivers 5 (e.g. in the independent box or integrated in the control unit of the moulding press).

In particular, the memory 4 supplied to the purchaser of the moulding apparatus will be provided already containing—therein—a high number of different pre-set instructions, designated for different injection systems.

In order to combine the specific hot channel injection system (and thus the specific mould) with the correct moulding instructions, there is provided a secondary memory 6 fixed to the mould 1, basically corresponding to a recognition device (e.g. an electronic chip, radio-frequency identification—“RFID”—tag, etc.) applied on the mould (e.g. on a plate, on a wiring structure, on a single motor).

Connecting the independent box containing the primary memory 4 and drivers 5 to the secondary memory 6 fixed to the mould 1, enables automatically combining the specific injection system (mould) with the correct moulding instruction from among the many stored in the primary memory 4.

This embodiment enables cutting costs further, given that the primary memory 4 and drivers 5 are common to several injection systems, besides a further reduction of the overall dimensions on the mould, given that all that is required is to provide the secondary memory 6 and the relative connection 8 and memory 10 connectors.

When setting the instructions in the primary memory 4 (external in this case) by the supplier or the user, all options described above regarding regarding the first embodiment shall apply.

The connection of the independent external box with the primary memory 4 or the secondary memory 6 fixed to the mould 1, occurs by means of the connectors 8 for connecting to the motors and respective encoders or resolvers used in the systems according to the prior art, in particular those providing for the use of a stand-alone electronic control unit.

In this manner, the user can at any time pass to a more advanced, flexible and precise system that enables setting further parameters or displaying further results (but with a considerably higher cost and overall dimension).

According to an advantageous characteristic, the external independent box containing the drivers 5 and possibly the primary memory 4 can be modular, so that it can be potentially combined with injection systems with different characteristics, in particular depending on the number of electric motors.

Furthermore, a single driver can be combined to one or more electric motors.

Just like in the prior art, the start input of the moulding cycle preferably comes from the control panel of the moulding press 11 or from a conventional sequential control unit. Upon receiving the input, the drivers 5 control the electric motors according to the instructions downloaded from the primary memory 4.

To summarise, the distinctive characteristics of the invention can be summarised as follows:
the drivers 5 are no longer fixed to the mould 1, a memory (4 or 6) remains fixed to the mould and serves as an identity card.
   The primary memory 4 remains fixed to the mould 1; connecting drivers 5 to the memory 4 enables downloading the instructions automatically;
   the primary memory 4 alongside the drivers 5, contains a high number of possible instructions; the secondary memory 6 is fixed to the mould 1; connecting the drivers 5 to the secondary memory 6 enables combining the mould 1 with the correct instruction from among the stored instructions.

Position of the drivers 5:
in a generic box not fixed to the mould 1;
in a box fixed to the moulding press 2 (independent or safety interface box);
integrated in the control unit of the moulding press.

Position of the memory (primary 4 and/or secondary 6) fixed to the mould 1:
in a box fixed to a plate;
in a box fixed to the wiring support structure of the distributor;
integrated in the single electric motors.

Configuration of the memory 4 (by supplier or by user):
manually:
   on box by means of potentiometers;
   on box by means of push buttons;
   on box by means of a human-machine interface such as a control panel 9 (e.g. PLC);
   by means of a human-machine interface such an outer universal control panel 9 (e.g. PLC);
   through a control panel of the moulding press 11;
   through electronic devices (e.g. PC, tablet, smartphone) through a dedicated software.
Automatically:
   uploaded by means of a port and/or external medium (USB flash drive, SD card) based on simulation software results (Moldovo®).
The possibility to pass—at any time—to an advanced system with a stand-alone electronic unit, given that the connectors 8 for connecting to the motors and the respective encoders or resolvers on the mould 1 are the same;
modular box driver so as to enable combining with systems which are very different from each other (e.g. according to the number of electric motors to be managed);
a driver can control one or more motors;
the moulding cycle start input comes from the control panel of the moulding press 11 or conventional sequential control unit.

Types of motors that can be used (brushless, asynchronous, etc.) and operating mechanism (drive, screw-holder nut, etc.) according to the prior art (PCT/IB2016/056168).

The advantages arising from the invention as compared to solutions provided for in the prior art (stand-alone power supply and control unit; power supply and control unit fixed—in its entirety—to the mould) can be summarised as follows:
cutting costs given that it is sufficient to provide only one pack of external drivers 5 (possibly with primary memory) which can be used for all systems;
reducing the overall dimensions on the mould 1 given that the drivers 5 and possibly the primary memory 4 too are carried to the external;
reducing start-up times and errors of the system given that it is sufficient to connect the drivers 5 to the primary 4 or secondary 6 memory fixed to the mould 1 to download the correct moulding instructions automatically.

Obviously, the construction details and the embodiments may vary with respect to what has been described and illustrated by way of example, without departing from the scope of protection of the invention as described in the claims that follow.

1. An apparatus for injection moulding of plastic materials, including:
a mould,
at least one injector having a valve pin actuated by an electric motor, and
a supply and control unit of the electric motor including a memory and remote control drivers of the electric motor operatively connected to said memory,
wherein said memory includes a primary memory and a secondary memory of which one of the primary memory and the secondary memory is secured to the mould and the other of the primary memory and secondary memory is at a remote position with respect to the mould.

2. The apparatus according to claim 1, wherein said remote control drivers are arranged at a remote position with respect to the mould.

3. The apparatus according to claim 1, wherein said secondary memory is secured to the mould and is a recognition device of the mould.

4. The apparatus according to claim 2, wherein said remote control drivers are arranged in a box which is not fixed to the mould.

5. The apparatus according to claim 2, wherein said remote control drivers are arranged in a box fixed to a moulding press of the apparatus.

6. The apparatus according to claim 2, wherein said remote control drivers are integrated in an electronic control unit of a moulding press of the apparatus.

7. The apparatus according to claim 1, wherein said primary memory is arranged in a box fixed to a plate of the mould.

8. The apparatus according to claim 1, wherein said primary memory is arranged in a box fixed to a wiring support structure of a plastic material distributor.

9. The apparatus according to claim 1, wherein said primary memory is integrated with said electric motor of said at least one injector.

10. The apparatus according to claim 4, wherein said primary memory is configurable by a manufacturer or by a user according to one or more of the following modes:
manual configuration modes:
on the box by use of potentiometers;
on the box by use of push buttons;
on the box by use of a human-machine interface;
through a separate human-machine interface;
through a control panel of the moulding press; or
through use of portable electronic devices through a dedicated software; or
automatic configuration mode:
through a port and/or external support based on simulation software results.

11. The apparatus according to claim 1, wherein instructions can be downloaded in an automatic fashion by connecting the remote control drivers to the primary and secondary memory.

12. The apparatus according to claim 11, wherein connection takes place through a memory connector fixed to the mould.

13. The apparatus according to claim 3, wherein said recognition device of the mould includes an electronic chip or a radio-frequency identification tag.

14. The apparatus of claim 1, wherein said secondary memory is secured to the mould, and said primary memory and said remote control drivers are both integrated into a box located remote from said mould and from a moulding press associated with the apparatus, and wherein said secondary memory is a recognition device of the mould.
